(19) United States
(12) Patent Application Publication
(10) Pub. No.: US 2021/0057129 A1
(43) Pub. Date: Feb. 25, 2021

(54) COAXIAL CABLE WITH TWO HOUR CIRCUIT INTEGRITY

(71) Applicant: Ademco Inc., Golden Valley, MN (US)

(72) Inventors: Ronald Caplette, Trevor, WI (US); Brian Meachum, Pleasant Prairie, WI (US); Daniel Dunar, Mequon, WI (US)

(21) Appl. No.: 16/544,285

(22) Filed: Aug. 19, 2019

(51) Int. Cl. H01B 7/295; H01B 7/02; H01B 11/18

(52) U.S. Cl. CPC H01B 7/295; H01B 11/1808; H01B 7/0275

(57) ABSTRACT

A coaxial cable with two hour circuit integrity is provided and can include an inner conductor, an outer conductor, an insulating layer disposed between the inner conductor and the outer conductor that includes a polymer support structure and air pockets that act as a dielectric for a signal transmitted through the inner conductor, an outer jacket, and a flame barrier disposed between the outer jacket and the outer conductor to avoid choking the signal, wherein the flame barrier can prevent fire from advancing from the outer jacket to the outer conductor for at least two hours.

### FIELD

The present invention relates generally to coaxial cables. More particularly, the present invention relates to a coaxial cable with two hour circuit integrity.

### BACKGROUND

Known coaxial cables used in antenna systems and other radio frequency applications are not constructed to meet existing circuit integrity fire test requirements, such as UL 2196 and UL 263, while maintaining sufficient transmission capability. Instead, to keep a circuit functioning for two hours as required by the circuit integrity fire test requirements, known coaxial cables employ flame and heat barriers inside of an outer conductor of the coaxial cables or in conjunction with a solid insulation system. However, these known cable designs have a reduced throughput and/or choke signals traveling therethrough when compared to similar coaxial cables without such flame and heat barriers.

In view of the above, there is a need and an opportunity for improved coaxial cables.

### BRIEF DESCRIPTION OF THE DRAWINGS

FIG. 1 is a cross-sectional view of a coaxial cable in accordance with disclosed embodiments.

### DETAILED DESCRIPTION

While this invention is susceptible of an embodiment in many different forms, specific embodiments thereof will be described herein in detail with the understanding that the present disclosure is to be considered as an exemplification of the principles of the invention. It is not intended to limit the invention to the specific illustrated embodiments.

Circuit integrity fire test requirements, such as UL 2196 and UL 263, require that a cable maintain operation for up to two hours in the presence of a catastrophic fire event. Accordingly, embodiments disclosed herein can include a coaxial cable with two hour circuit integrity and a method for manufacturing the coaxial cable. In some embodiments, the coaxial cable disclosed herein can be used to maintain a connection between emergency first responders and a home base of the emergency first responders.

In some embodiments, the coaxial cable disclosed herein can include an inner conductor, an outer conductor, an insulating layer disposed between the inner conductor and the outer conductor that includes a polymer support structure and air pockets that act as a dielectric for a signal transmitted through the inner conductor, an outer jacket, and a flame barrier disposed between the outer jacket and the outer conductor to avoid choking the signal. Furthermore, in some embodiments, the flame barrier can prevent fire from advancing from the outer jacket to the outer conductor for at least two hours.

In some embodiments, the polymer support structure can be deployed in a star configuration having four prongs, and in these embodiments, the air pockets can surround at least a portion of the star configuration. However, it is to be understood that other configurations of the polymer support structure that allow for airflow, for example, by being surrounded, at least in part, by the air pockets, are contemplated. For example, embodiments of the polymer support structure with more than four prongs and less than four prongs are contemplated.

Various embodiments of different materials are contemplated for the flame barrier and the center conductor. For example, in some embodiments, the flame barrier can include mineral filled silicone, and in some embodiments, the center conductor can include copper clad steel or copper clad aluminum.

In some embodiments, a dielectric constant of the flame barrier can be higher than a dielectric constant of the polymer support structure and a dielectric constant of the air pockets. In these embodiments, if the flame barrier were disposed inside of the outer conductor, then the flame barrier would choke the signal.

In some embodiments, the coaxial cable can include a first heat barrier disposed between the flame barrier and the outer conductor and a second heat barrier disposed between the first heat barrier and the flame barrier. In such embodiments, the first heat barrier and the second heat barrier can work with the flame barrier to prevent the fire from advancing from the outer jacket to the outer conductor. In some embodiments, the first heat barrier can include mica tape, and the second heat barrier can include PTFE tape. However, in some embodiments, the first heat barrier can include PTFE tape, and the second heat barrier can include mica tape.

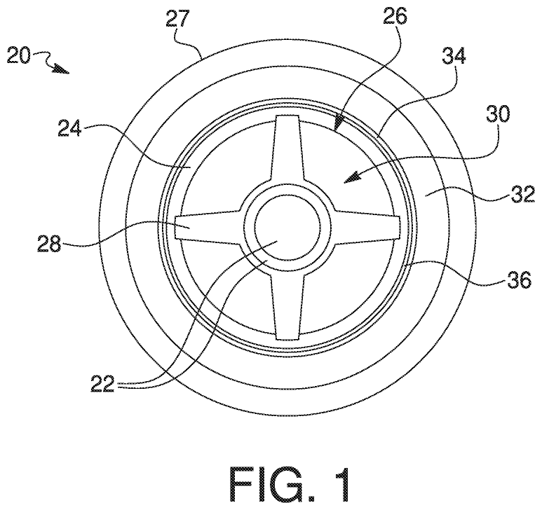

FIG. 1 is a cross-sectional view of a coaxial cable 20 in accordance with disclosed embodiments. As seen in FIG. 1, the coaxial cable 20 can include an inner conductor 22, an outer conductor 24, an insulating layer 26, an outer jacket 27, a flame barrier 32, a first heat barrier 34, and a second heat barrier 36. As further seen in FIG. 1, in some embodiments, the insulating layer can be disposed between the inner conductor 22 and the outer conductor 24 and can include a polymer support structure 28 and air pockets 30 that can act as a dielectric for a signal transmitted through the inner conductor 22. The flame barrier 32 can be disposed between the outer jacket 27 and the outer conductor 24 to avoid choking the signal and can work with the first heat barrier 34 and the second heat barrier 36 to prevent fire from advancing from the outer jacket 27 to the outer conductor 24 for at least two hours.

In some embodiments, the outer jacket 27 can be approximately 0.03 inches thick with an outside diameter of approximately 0.805 inches, the flame barrier 32 can be approximately 0.08 inches thick with an outside diameter of approximately 0.745 inches, the first heat barrier 34 can be approximately 0.01 inches thick with an outside diameter of approximately 0.585 inches, the second heat barrier 36 can be approximately 0.01 inches thick with an outside diameter of approximately 0.565 inches, the outer conductor 24 can be approximately 0.034 inches thick with an outside diameter of approximately 0.545 inches, the insulating layer 26 can be approximately 0.144 inches thick with an outside diameter of approximately 0.477 inches, and/or the inner conductor 22 can be approximately 0.189 inches thick and have an outside diameter of equal value.

Although a few embodiments have been described in detail above, other modifications are possible. For example, the logic flows described above do not require the particular order described or sequential order to achieve desirable results. Other steps may be provided, steps may be eliminated from the described flows, and other components may be added to or removed from the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

1. A coaxial cable comprising:
an inner conductor;
an outer conductor;
an insulating layer disposed between the inner conductor and the outer conductor that includes a polymer support structure and air pockets that act as a dielectric for a signal transmitted through the inner conductor;
an outer jacket;
a flame barrier disposed between the outer jacket and the outer conductor to avoid choking the signal;
a first heat barrier disposed between the flame barrier and the outer conductor; and
a second heat barrier disposed between the first heat barrier and the flame barrier wherein a combined thickness of the first heat barrier and the second heat barrier is less than a thickness of the flame barrier,
wherein the flame barrier works with the first heat barrier and the second heat barrier to prevent fire from advancing from the outer jacket to the outer conductor for at least two hours, and
wherein a first dielectric constant of the flame barrier is higher than a second dielectric constant of the polymer support structure and a third dielectric constant of the air pockets.

2. (canceled)

3. The coaxial cable of claim 1 wherein, if the flame barrier were disposed inside of the outer conductor, the flame barrier would choke the signal.

4. (canceled)

5. The coaxial cable of claim 1 wherein the first heat barrier includes mica tape, and wherein the second heat barrier includes PTFE tape.

6. The coaxial cable of claim 1 wherein the first heat barrier includes PTFE tape, and wherein the second heat barrier includes mica tape.

7. The coaxial cable of claim 1 wherein the polymer support structure is deployed in a star configuration, and wherein the air pockets surround at least a portion of the star configuration.

8. The coaxial cable of claim 1 wherein the flame barrier includes mineral filled silicone.

9. The coaxial cable of claim 1 wherein the center conductor includes copper clad steel.

10. The coaxial cable of claim 1 wherein the center conductor includes copper clad aluminum.

11. A method comprising:
providing an inner conductor of a coaxial cable;
providing an insulating layer around the inner conductor that includes a polymer support structure and air pockets that act as a dielectric for a signal transmitted through the inner conductor;
providing an outer conductor around the insulating layer;
providing a flame barrier around and outside of the outer conductor to avoid choking the signal;
providing an outer jacket around the flame barrier
providing a first heat barrier around the outer conductor and between the flame barrier and the outer conductor; and
providing a second heat barrier around the first heat barrier and between the first heat barrier and the flame barrier, wherein a combined thickness of the first heat barrier and the second heat barrier is less than a thickness of the flame barrier,
wherein the flame barrier works with the first heat barrier and the second heat barrier to prevent fire from advancing from the outer jacket to the outer conductor for at least two hours, and
wherein a first dielectric constant of the flame barrier is higher than a second dielectric constant of the polymer support structure and a third dielectric constant of the air pockets.

12. (canceled)

13. The method of claim 11 wherein, if the flame barrier were disposed inside of the outer conductor, the flame barrier would choke the signal.

14. (canceled)

15. The method of claim 11 wherein the first heat barrier includes mica tape, and wherein the second heat barrier includes PTFE tape.

16. The method of claim 11 wherein the first heat barrier includes PTFE tape, and wherein the second heat barrier includes mica tape.

17. The method of claim 11 further comprising:
deploying the polymer support structure in a star configuration; and
the air pockets surrounding at least a portion of the star configuration.

18. The method of claim 11 wherein the flame barrier includes mineral filled silicone.

19. The method of claim 11 wherein the center conductor includes copper clad steel.

20. The method of claim 11 wherein the center conductor includes copper clad aluminum.

21. The coaxial cable of claim 1 wherein the second heat barrier contacts the first heat barrier.

22. The method of claim 11 wherein the second heat barrier is provided so as to contact the first heat barrier.
